(19) United States
(12) Patent Application Publication
(10) Pub. No.: US 2017/0141661 A1
(43) Pub. Date: May 18, 2017

(54) CAGE ROTOR

(71) Applicant: Siemens Aktiengesellschaft, Munchen (DE)

(72) Inventors: Ralf Fischer, Nürnberg (DE); Markus Reinhard, Ludwigshafen (DE)

(73) Assignee: Siemens Aktiengesellschaft, Munchen (DE)

(21) Appl. No.: 15/352,107

(22) Filed: Nov. 15, 2016

(30) Foreign Application Priority Data
Nov. 16, 2015 (EP) 15194761.1

(51) Int. Cl. H02K 17/16; H02K 15/00

(52) U.S. Cl. CPC H02K 17/165; H02K 15/0012

(57) ABSTRACT

A cage rotor of an asynchronous machine includes radially closed or partially opened slot recesses. Arranged in the slot recesses are conductor bars which are fixed in the slot recesses by a metal foam. The slot recesses can be produced by punching individual sheet metals which are then stacked to form a laminated core. A short-circuit ring can be attached at one end face of the laminated core to contact the conductor bars.

### CROSS-REFERENCES TO RELATED APPLICATIONS

This application claims the priority of European Patent Application, Serial No. EP15194761.1, filed Nov. 16, 2015, pursuant to 35 U.S.C. 119(a)-(d), the content of which is incorporated herein by reference in its entirety as if fully set forth herein.

### BACKGROUND OF THE INVENTION

The invention relates to a cage rotor of an asynchronous machine, an asynchronous machine, the use thereof, and to a method for manufacturing a cage rotor of an asynchronous machine.

The following discussion of related art is provided to assist the reader in understanding the advantages of the invention, and is not to be construed as an admission that this related art is prior art to this invention.

Cage rotors of asynchronous machines have been known and proven for a long time. Over the course of time different forms of cage bars have developed for various applications of asynchronous machines. The cage bars each having specific electrical properties, and thus being particularly suited for these applications. Therefore double cages in which two or more bars are inserted into a rotor slot are frequently used in high-torque applications. Other bar forms which benefit the current displacement effect are also frequently used.

In this way conductor bars up to a certain size are introduced into the rotor by means of an aluminum pressure casting process. In the case of machines with a larger diameter, each bar is however introduced manually into the rotor. However, a separate lamination of a rotor sheet is required for each bar form. This lamination defines the form of the conductor bar in the case of a pressure casting method. With inserted bars, the rotor slot will likewise emulate the bar form in order to obtain a correspondingly fixed seat of the bars by means of a form-fit.

The need to provide a separate lamination for each bar form is disadvantageous here and indicates a significant outlay in respect of the plurality of different tools required for the production of the sheet metals. This plurality of special punching tools is very capital-intensive and these punching tools also only permit a limited useful life due to wear and tear.

It would therefore be desirable and advantageous to provide an improved cage rotor to obviate prior art shortcomings.

### SUMMARY OF THE INVENTION

According to one aspect of the present invention, a cage rotor of an asynchronous machine includes radially closed or partially opened slot recesses, conductor bars arranged in the slot recesses, and a metal foam configured to fix the conductor bars in the slot recesses.

The provision of a cage rotor according to the present invention enables a reduction in the number of punching tools that have to be provided, and also a reduction in the variety of laminations. In addition, a cage rotor according to the present invention is easily suitable for a modular system of an asynchronous motor. Depending on the intended application of the asynchronous machine, different conductor cross-sections should also be realized with an axle height. Furthermore, a cage rotor of this type is easy to produce.

According to another aspect of the present invention, a dynamo-electric machine includes at least one cage rotor which includes radially closed or partially opened slot recesses, conductor bars respectively arranged in the slot recesses, and a metal foam configured to fix the conductor bars in the slot recesses.

According to another advantageous feature of the present invention, the dynamo-electric machine can be constructed in the form of a rotary asynchronous dynamo-electric machine or linear asynchronous dynamo-electric machine.

According to still another aspect of the present invention, a machine tool, E-car or rail vehicle includes at least one dynamo-electric machine which includes at least one cage rotor which includes radially closed or partially opened slot recesses, conductor bars respectively arranged in the slot recesses, and a metal foam configured to fixed the conductor bars in the slot recesses.

According to still another aspect of the present invention, a method for producing a cage rotor includes punching individual sheet metals with slot recesses, stacking the sheet metals to form a laminated core, inserting conductor bars into the slot recesses, and filling the slot recesses with metal foam.

In accordance with the present invention, manufacture of a cage rotor now only includes a single universal lamination particularly for one axle height. This universal lamination has comparably larger and universal slot recesses. These recesses can be freely selected in terms of their embodiments and are embodied here to be circular, ellipsoidal, rectangular, polygonal or trapezoidal for instance.

In a circumferential direction of a sheet metal, all recesses are considered to have the same cross-section. Variation possibilities of the slot recesses per sheet metal are, however, also possible. Furthermore, different variants are also possible axially within a laminated core of the rotor. In this way each sheet metal has the same geometric dimensions of the slot recesses but geometric forms and or dimensions of the slot recesses which differ from the axially following sheet metal of the rotor. An axially recurring sequence of sheet metal with an identical lamination is thus also possible.

An essential feature of the present invention is that the conductor bars can be inserted axially into the slot recesses with a sufficient radial play. Both the geometric embodiments and the dimensions of the slot recess influence the magnetic behavior of the cage rotor and ultimately the intended operating behavior of the asynchronous machine.

The conductor bars can be introduced axially into these slot recesses of the sheet metal or the laminated core. The conductor bars, however, need not necessarily have a tight press fit in the slot recess. Especially when smaller machines are involved, the entire cage can be introduced into the rotor laminated core. In this way, the conductor bars can already be connected on one end face of the laminated core to a short-circuit ring and form what is known as a half cage. A minimum dimension of the bar height is also already sufficient here.

Metal foams have low density due to pores and cavities. It is thus possible to realize a low weight with high specific rigidity and solidity. Foams of this type can be manufactured from different metals, such as copper, zinc, steel or iron by using suitable foaming agents.

Metal foam can be manufactured, for example, by using metal powder and a metal hydride. Both powders are mixed with one another and then compressed by hot pressing or by extrusion molding to form a primary material. This primary material is then heated to a temperature above the melting point of the respectively used metal. Here the metal hydride sets gaseous hydrogen free and foams the mixture. Alternatively to this manufacturing method, gas can be blown into a molten metal, which was previously made foamable by adding solid components. Spray-applied foam can likewise be a suitable manufacturing method of the metal foam.

A metal foam produced by any of the manufacturing methods, as described above by way of example above, can also be divided into single-phase foam, dual-phase foam and multi-phase foam. The single-phase foam can have metallic hollow balls as a preform for instance. The two-phase foam can have ceramic hollow balls coated with metal as a preform for instance. The multi-phase foam can have ceramic hollow balls with an additional binding agent. Metal foams can be embodied variably such that these can be distinguished by a large plurality of different structures and material properties. The porosity of the foams created by cavities or pores considerably reduces the density of the components provided in the slot recesses and thus the overall weight of the rotor.

Other traditional production methods similar to produce a foamed material may also be suitable to produce a metal foam. This contains a physical foaming, in which the material is foamed by a physical process.

Foaming can also be realized on a chemical basis. A foaming agent, in most cases in the form of what is known as a master batch granulate, is added during chemical foaming for instance. A non-permanent component of the foaming agent can then be separated by supplying heat, which results in a foaming of the molten metal. A further option involves mechanical foaming, in which air or another gas can be stirred into the metal to be foamed or a metallic paste for instance. By cross-linking the metal or by gelling the paste, the metal foam is solidified.

The conductor bars are inserted into the slot recesses, which can be embodied to be circular, elliptical, rounded or polygonal for instance and in the remaining space of the slot recess a magnetically conductive metal foam, e.g. filled on a nickel or iron basis, which, after foaming and, if necessary, additionally by heating takes up the entire residual space of the slot recess. As a result, the conductor bar is fixed in the slot recess and adequate magnetic conductivity is produced. Depending on the pore size and material of the metal foam, a magnetic conductivity is established in the slot recess, which in each case lies above the magnetic conductivity of air.

The magnetic field guidance permits a flow which mainly flows through the rotor iron also in the region of the slot recesses displaced with metal foam. The force development therefore starts here, so that the force development is already better than with a thicker slot insulation, e.g. of slip ring rotors.

The metal foam, which is used as filler material between the conductor bar and the laminated core, is magnetically conductive and therefore represents a subsequent adjustment of the rotor iron to the bar. At the same time, the ohmic resistance of metal foam is significantly higher than that of the electrical sheet, which indicates a type of insulation of the bar in the slot and thus results in lower eddy current losses compared with the conventional design with cast bars. The lower density of the foam compared with normal electrical sheet reduces the gyrating mass compared with the comparably known laminated cores of the rotor. A highly dynamic machine is thus possible.

The conductor bars are introduced axially into these slot recesses of the sheet metal or the laminated core. The conductor bars, however, need not necessarily have a tight press fit in the slot recess. Especially with smaller machines, the entire cage is introduced into the rotor laminated core, in this way the conductor bars are already connected on one side to a short-circuit ring and form what is known as a half cage. A minimum dimension of the bar height is also already sufficient here.

Due to the “chaotic” manufacturing method, the pores of the metal foam have a different or similar geometric form. The dimensions can range from a few pm to a few mm.

The magnetic conductivity of the metal foam depends predominantly on the number and/or size and/or distribution of the pores and/or the web widths thereof and also on the material of the within the slot recess.

A considerable synergy effect is induced by the use of just one single universal laminated core per axle height and nevertheless further admits the possibility of different bar forms in order to cover diverse applications, such as current displacement rotors, round bar rotors etc. This results in significant cost advantages without in the process having to forgo technical advantages.

The lower density of the metal foam compared with normal electrical sheet additionally reduces the gyrating mass compared with the comparably known inertially-loaded laminated cores of the rotor.

A highly-dynamic asynchronous machine is thus possible for various applications, such as is required for instance in machine tools, in electrical drives in E-cars and rail vehicles.

The cage rotor of the asynchronous machine can be configured with radially closed or partially opened slot recesses or slots, which influences the slot leakage reactance and thus the operation of the asynchronous machine.

The partially opened slots are created here, in particular, by the metal removal turning of the rotor laminated core. The partial opening of the slot after the turning can be designed by the geometric design in particular of the radially outer region of the slot recess. In other words, after the turning, a round slot results in a partial opening of the slot which differs from a triangular slot recess.

The slot detent torques of the rotor are reduced, inter alia, by the axial skewing of the slots and thus the conductor bars in terms of their axial course.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a longitudinal section of an asynchronous machine according to the present invention;

FIG. 2 is a cross-section through a cage rotor according to the present invention;

FIG. 3 is a perspective illustration of a half cage; and

FIGS. 4 to 6 are cutaway views a rotor sheet with different shapes of a conductor bar in a slot recess of the cage rotor.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

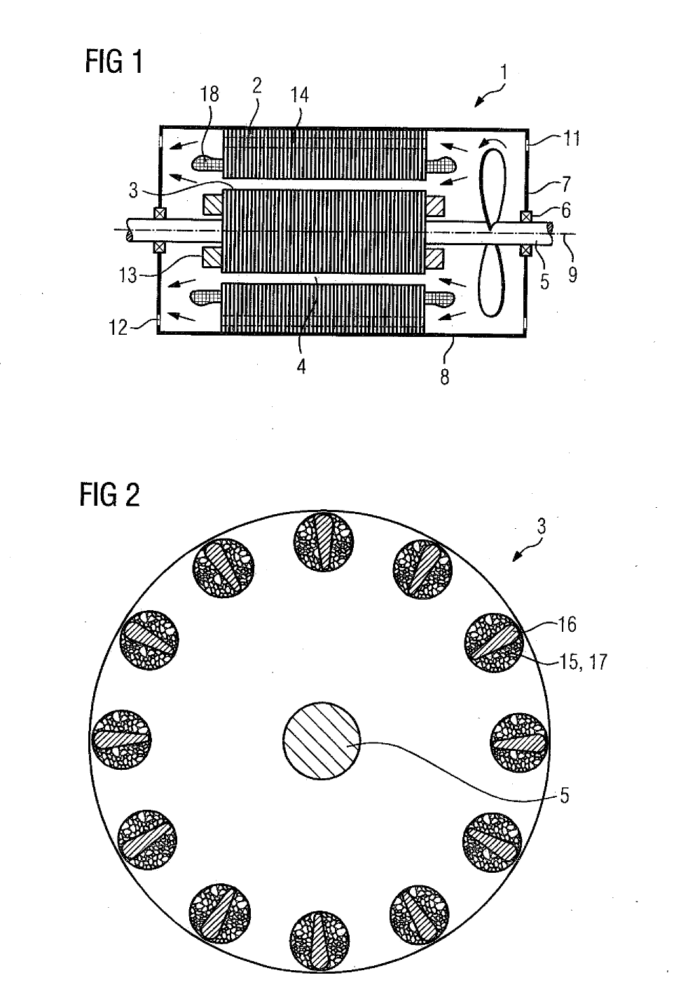

Turning now to the drawing, and in particular to FIG. 1, there is shown a longitudinal section of an asynchronous machine, generally designated by reference numeral 1 and arranged in a housing 8. The asynchronous machine 1 has a stator 2, which is embodied bundled in laminations in an axial direction and which has a winding system 18, which is arranged in slots, which point to an air gap in the dynamo-electric machine 1. Substantially axially-running cooling ducts 14, through which a cooling air can pass, are arranged in the region of the rear of the laminated core of the stator 2.

A rotor 3, in this case, a short-circuit cage rotor, which is connected in a torque-proof manner with a shaft 5 which rotates about an axis 9, is arranged at a distance from the stator 2 through the air gap 4. The shaft 5 is supported by way of bearings 6 in the bearing shields 11 arranged in the housing 8. The bearing shields 7 have inlets 11 or outlets 12, in order to be able to operate the dynamo-electric machine 1 as an enclosed-ventilated machine.

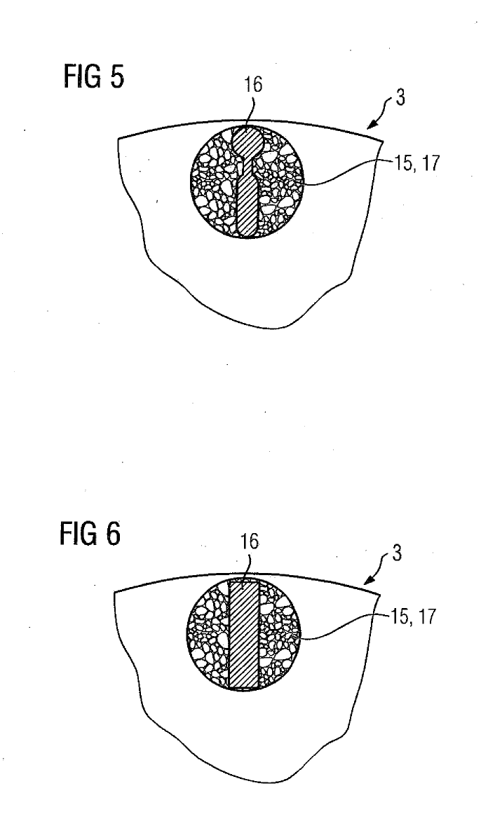

FIG. 2 shows the rotor 3 with twelve slot recesses 15, in which, a conductor bar 16 is arranged in each case. The slot recess 15 is dimensioned significantly larger here than the conductor bar 16 itself, and thus represents, a universal lamination for other cage rotors of the same axle height. Conductor bars can thus now be used inserted into the slot recess 15, such as FIGS. 4 to 6 show, i.e. essentially double bars for double bar rotors with a different shape or also high bar cross-sections. Self-evidently also in the cross-section round bars or trapezoid bars can be inserted into the slot recesses 15.

Just one bar is normally provided per slot recess 15, however, slot recesses 15, in which, two or a number of bars are arranged are also conceivable. This reduces skin effects which can occur with bars with larger cross-sections. In accordance with the invention the remaining “cavities” are also provided here with metal foam.

In accordance with the invention the remaining space, in other words the “cavity”, between the conductor bars and the interior of the slot recess 15 is lined with a metal foam 17. The result is a fixing of the conductor bars 16 in the slot recess 15, and also a type of insulation of the conductor bar 16 relative to the laminated core of the rotor 3, similarly to an adequate magnetic conductivity in order to guarantee current displacement effects.

For graphical reasons the webs of the metal foam 17 or its pores in the slot recess 15 in FIGS. 2, 4, 5, and 6 are shown partially over dimensioned.

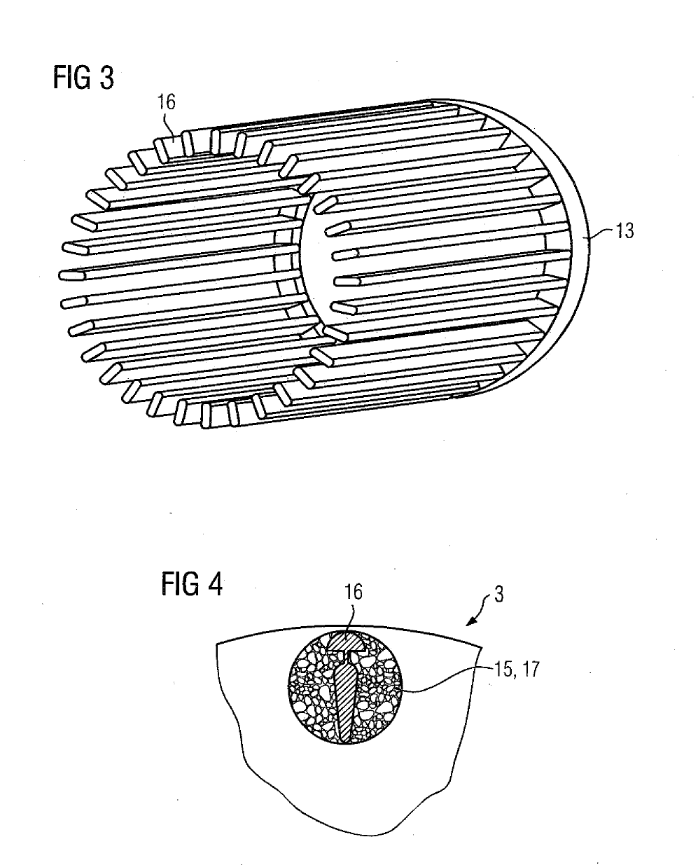

Either individual or a number of conductor bars 16 or a half cage according to FIG. 3 are inserted into the slot recesses 15. Here conductor bars 16 are already welded, cast or soldered on one side of a short-circuit ring 13, wherein the overall half cage is then inserted into a laminated core with slot recesses 15.

Advantageously a skewing of the slots can be created by twisting the laminated core about the axis 19, which is advantageous for reducing the torque ripple of the asynchronous machine.

In the method for producing a cage rotor of this type, the missing short circuit rings are now naturally to be contacted or welded or soldered to the conductor bars protruding axially out of the laminated core.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A cage rotor of an asynchronous machine, comprising:
radially closed or partially opened slot recesses;
conductor bars arranged in the slot recesses; and
a metal foam configured to fix the conductor bars in the slot recesses.

2. The cage rotor of claim 1, wherein the metal foam includes a metal selected from the group consisting of copper, zinc, steel, iron, and any combination thereof, in combination with a foaming agent.

3. A dynamo-electric machine, comprising at least one cage rotor which includes radially closed or partially opened slot recesses, conductor bars arranged in the slot recesses, and a metal foam configured to fixed the conductor bars in the slot recesses.

4. The dynamo-electric machine of claim 3, constructed in the form of a rotary asynchronous dynamo-electric machine or linear asynchronous dynamo-electric machine.

5. A machine tool, E-car or rail vehicle, comprising at least one dynamo-electric machine comprising at least one cage rotor which includes radially closed or partially opened slot recesses, conductor bars arranged in the slot recesses, and a metal foam configured to fixed the conductor bars in the slot recesses.

6. A method for producing a cage rotor, comprising:
punching individual sheet metals with slot recesses;
stacking the sheet metals to form a laminated core;
inserting conductor bars into the slot recesses; and
filling the slot recesses with metal foam;

7. The method of claim 6, wherein the conductor bars are received in the slot recesses by placing individual conductor bars into the slot recesses.

8. The method of claim 7, further comprising placing a short-circuit rings at each of both end faces of the laminated core to connect the conductor bars on both end faces to one another.

9. The method of claim 6, further comprising contacting a short-circuit ring at one of the end faces of the laminated core to the conductor bars, before the conductor bars are inserted into the slot recesses, to form a half-cage, and contacting the conductor bars at the other one of the end faces of the laminated core with one another, after the half-cage with the conductor bars have been inserted in the slot recesses.

10. The method of claim 6, further comprising rotating the laminated core in a predeterminable circumferential direction to produce a slot skewing to thereby form cavities between the conductor bars and the slot recesses; and filling the cavities with the metal foam.

11. The method of claim 6, wherein the slot recesses are produced by turning the cage rotor in a metal removing manner.

12. The method of claim 11, wherein the slot recesses produced by turning the cage rotor in a metal removing manner are partially open.

13. The method of claim 6, wherein the metal foam is made from a metal selected from the group consisting of copper, zinc, steel, iron, and any combination thereof, in combination with a foaming agent.
